(19) United States
(12) Patent Application Publication
(10) Pub. No.: US 2026/0051759 A1
(43) Pub. Date: Feb. 19, 2026

(54) SELF-LOCKING POWER SUPPLY CIRCUIT

(71) Applicant: Cheng Uei Precision Industry Co., Ltd., New Taipei City (TW)

(72) Inventors: Chih Chieh Fang, New Taipei City (TW); Yung Mao Wu, New Taipei City (TW)

(21) Appl. No.: 19/059,401

(22) Filed: Feb. 21, 2025

(30) Foreign Application Priority Data
Aug. 16, 2024 (CN) 202421998314.0

(51) Int. Cl. H02J 7/00

(52) U.S. Cl. CPC H02J 7/00712; H02J 7/0063

(57) ABSTRACT

A self-locking power supply circuit includes the battery, a grounding end, an outputting end, a mode switching end, a P-channel metal oxide semiconductor (PMOS) transistor, an N-channel metal oxide semiconductor (NMOS) transistor and a first resistor. The P-channel metal oxide semiconductor (PMOS) transistor includes a first source electrode electrically connected to the outputting end, a first drain electrode electrically connected to the battery, and a first gate electrode. The N-channel metal oxide semiconductor (NMOS) transistor includes a second source electrode electrically connected to the grounding end, a second drain electrode electrically connected to the first gate electrode, and a second gate electrode electrically connected to the mode switching end. One end of the first resistor is connected between the battery and the first drain electrode, and the other end of the first resistor is connected between the first gate electrode and the second drain electrode.

### CROSS REFERENCE TO RELATED APPLICATIONS

The present application is based on, and claims priority from, China Patent Application No. 202421998314.0, filed Aug. 16, 2024, the disclosure of which is hereby incorporated by reference herein in its entirety.

### BACKGROUND OF THE INVENTION

### Field of the Invention

The present invention generally relates to a circuit, and more particularly to a self-locking power supply circuit that is able to lock a battery.

### Description of Related Art

During a transportation period of electronic products which are shipped from a factory to consumers to be used for the first time, batteries of the electronic products need locking due to a long period of inactivity, so the batteries are in states of minimal power consumption to prevent over discharges of the batteries to damage the electronic products. Currently, the consumers generally expect ready-to-use experiences of the consumers when the consumers purchase the electronic products. Therefore, it is necessary to balance the experiences of the consumers with safeties of the batteries during a long-term transportation of the electronic products, in that case, a design complexity of an overall power supply circuit is improved.

Thus, it is essential to provide an innovative self-locking power supply circuit, when a consumer initially uses an electronic device which includes a battery of the innovative self-locking power supply circuit, the innovative self-locking power supply circuit is able to lock the battery of the innovative self-locking power supply circuit to save power consumption and the battery is easily unlocked.

### BRIEF SUMMARY OF THE INVENTION

An object of the present invention is to provide a self-locking power supply circuit that is able to lock a battery. The self-locking power supply circuit includes the battery, a grounding end, an outputting end, a mode switching end, a P-channel metal oxide semiconductor (PMOS) transistor, an N-channel metal oxide semiconductor (NMOS) transistor and a first resistor. The P-channel metal oxide semiconductor (PMOS) transistor includes a first source electrode electrically connected to the outputting end, a first drain electrode electrically connected to the battery, and a first gate electrode. The N-channel metal oxide semiconductor (NMOS) transistor includes a second source electrode electrically connected to the grounding end, a second drain electrode electrically connected to the first gate electrode of the PMOS transistor, and a second gate electrode electrically connected to the mode switching end. One end of the first resistor is connected between the battery and the first drain electrode of the PMOS transistor, and the other end of the first resistor is connected between the first gate electrode of the PMOS transistor and the second drain electrode of the NMOS transistor.

Another object of the present invention is to provide a self-locking power supply circuit. The self-locking power supply circuit includes a battery, a grounding end, an outputting end, a mode switching end, a micro-controller connected to an electric voltage, a P-channel metal oxide semiconductor (PMOS) transistor, an N-channel metal oxide semiconductor (NMOS) transistor, a first resistor and a voltage stabilizer. The P-channel metal oxide semiconductor (PMOS) transistor includes a first source electrode electrically connected to the outputting end, a first drain electrode electrically connected to the battery, and a first gate electrode. The N-channel metal oxide semiconductor (NMOS) transistor includes a second source electrode electrically connected to the grounding end, a second drain electrode electrically connected to the first gate electrode of the PMOS transistor, and a second gate electrode electrically connected to the mode switching end. One end of the first resistor is connected between the battery and the first drain electrode of the PMOS transistor, and the other end of the first resistor is connected between the first gate electrode of the PMOS transistor and the second drain electrode of the NMOS transistor. The voltage stabilizer is connected between the outputting end and the micro-controller.

Another object of the present invention is to provide a self-locking power supply circuit. The self-locking power supply circuit includes a battery, a grounding end, an outputting end, a mode switching end, a micro-controller, a P-channel metal oxide semiconductor (PMOS) transistor, an N-channel metal oxide semiconductor (NMOS) transistor and a first resistor. One end of the micro-controller is connected to an electric voltage, and the other end of the micro-controller is connected to the mode switching end. The P-channel metal oxide semiconductor (PMOS) transistor includes a first source electrode electrically connected to the outputting end, a first drain electrode electrically connected to the battery, and a first gate electrode. The N-channel metal oxide semiconductor (NMOS) transistor includes a second source electrode electrically connected to the grounding end, a second drain electrode electrically connected to the first gate electrode of the PMOS transistor, and a second gate electrode electrically connected to the mode switching end. One end of the first resistor is connected between the battery and the first drain electrode of the PMOS transistor, and the other end of the first resistor is connected between the first gate electrode of the PMOS transistor and the second drain electrode of the NMOS transistor.

As described above, the self-locking power supply circuit arranges the PMOS transistor and the NMOS transistor to an electric power supply path of the battery. Furthermore, the micro-controller outputs signals at different levels, so the PMOS transistor and the NMOS transistor are conductive to make the electric power supply path of the battery be conductive, or the PMOS transistor and the NMOS transistor are turned off to disconnect the electric power supply path of the battery, so after the battery leaves a factory, an electric consumption of the battery is saved during a transportation period. At the same time, when a consumer initially uses an electronic device which includes the battery of the self-locking power supply circuit, the self-locking power supply circuit is able to lock the battery of the self-locking power supply circuit to save power consumption and the battery is easily unlocked, so that a simpler user experience is provided.

### BRIEF DESCRIPTION OF THE DRAWINGS

The present invention will be apparent to those skilled in the art by reading the following description, with reference to the attached drawings, in which:

FIG. 1 is a circuit diagram of a self-locking power supply circuit in accordance with a preferred embodiment of the present invention.

### DETAILED DESCRIPTION OF THE INVENTION

In order to provide a detailed explanation of a technical content, structural features, achieved purposes and effects of a self-locking power supply circuit, following examples of embodiments are provided with accompanying diagrams for a detailed illustration.

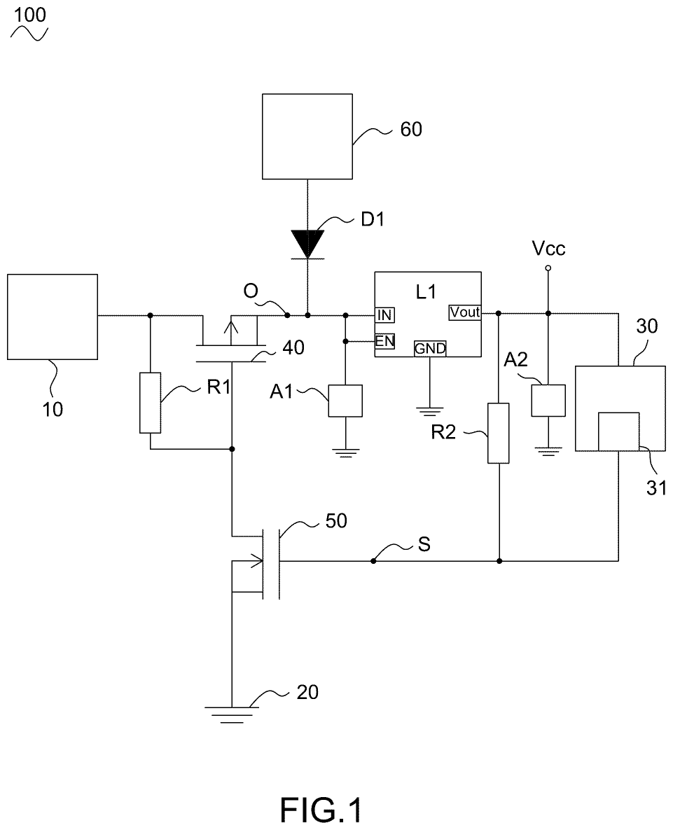

Referring to FIG. 1, a self-locking power supply circuit 100 according to a preferred embodiment of the present invention is shown. The self-locking power supply circuit 100 includes a battery 10, a grounding end 20, an outputting end O, a P-channel metal oxide semiconductor (PMOS) transistor 40, an N-channel metal oxide semiconductor (NMOS) transistor 50, a first resistor R1 and a mode switching end S.

The PMOS transistor 40 includes a first source electrode electrically connected to the outputting end O, a first drain electrode electrically connected to the battery 10, and a first gate electrode. The NMOS transistor 50 includes a second source electrode electrically connected to the grounding end 20, a second drain electrode electrically connected to the first gate electrode of the PMOS transistor 40, and a second gate electrode electrically connected to the mode switching end S. The PMOS transistor 40 and the NMOS transistor 50 are disposed to an electric power supply path of the battery 10.

One end of the first resistor R1 is connected between the battery 10 and the first drain electrode of the PMOS transistor 40, and the other end of the first resistor R1 is connected between the first gate electrode of the PMOS transistor 40 and the second drain electrode of the NMOS transistor 50. After the self-locking power supply circuit 100 is assembled, the NMOS transistor 50 has normally closed characteristics, so the first drain electrode of the PMOS transistor 40 is located at a high potential state, and then the PMOS transistor 40 is turned off and the battery 10 is prevented from discharging. Additionally, if a high potential signal is provided for the mode switching end S, the PMOS transistor 40 is turned on to be conductive, and the battery 10 is made to start supplying power.

Referring to FIG. 1 again, in order to facilitate switching a power supply state of the battery 10, the self-locking power supply circuit 100 further includes an external power supply 60, a voltage stabilizer L1, a diode D1 and a micro-controller 30. The voltage stabilizer L1 is connected to the outputting end O to output an appropriate voltage. The voltage stabilizer L1 is connected between the outputting end O and the micro-controller 30. The external power supply 60 is connected between the outputting end O and the voltage stabilizer L1. A negative electrode of the diode D1 is connected to the outputting end O, and a positive electrode of the diode D1 is electrically connected to the external power supply 60, so that a circuit between the external power supply 60 and the first source electrode of the PMOS transistor 40, and a circuit between the external power supply 60 and the voltage stabilizer L1 are both conductive unidirectionally. An inputting terminal IN and an enabling terminal EN of the voltage stabilizer L1 are electrically connected to the outputting end O. The voltage stabilizer L1 includes a grounding terminal GND and an outputting terminal Vout to provide the appropriate voltage for a load. The micro-controller 30 is equipped with a user interface and an outputting pin 31, and the micro-controller 30 is connected between the outputting terminal Vout and the mode switching end S. The outputting pin 31 is electrically connected with the mode switching end S. The outputting terminal Vout of the voltage stabilizer L1 is electrically connected to the micro-controller 30.

The micro-controller 30 outputs signals at different levels, so the PMOS transistor 40 and the NMOS transistor 50 are conductive to make the electric power supply path of the battery 10 be conductive, or the PMOS transistor 40 and the NMOS transistor 50 are turned off to disconnect the electric power supply path of the battery 10.

With the above setup, the battery 10 provides electric power for the micro-controller 30. When the battery 10 is turned off, the external power supply 60 provides the electric power. During a product assembling and testing period, the micro-controller 30 is controlled by the user interface to provide the high potential signal for the mode switching end S, so that the battery 10 continuously provides the electric power. After the product assembling and testing is completed, the micro-controller 30 is controlled via the user interface to provide a low potential signal to the mode switching end S, so the battery 10 stops supplying the electric power, and the battery 10 is prevented from being depleted during a product transportation period. When the product is delivered to an end user, the external power supply 60 is reconnected, the end user controls the micro-controller 30 via the user interface to provide the high potential signal to the mode switching end S, and then the battery 10 provides the electric power for the micro-controller 30.

In this preferred embodiment, the self-locking power supply circuit 100 is equipped with a second resistor R2, a first component A1 and a second component A2. One end of the second resistor R2 is connected between the voltage stabilizer L1 and the micro-controller 30, and the other end of the second resistor R2 is connected between the micro-controller 30 and the mode switching end S, an intensity of a current flowing to the mode switching end S is lowered, and a stable circuit operation is ensured. One end of the first component A1 is electrically connected between the outputting end O, and the inputting terminal IN and the enabling terminal EN of the voltage stabilizer L1, and the other end of the first component A1 is grounded to filter out current noises. The first component A1 is a capacitor, a filter or a circuit with a function which is similar to the capacitor or the filter, etc. One end of the second component A2 is electrically connected between the second resistor R2 and the micro-controller 30, and the other end of the second component A2 is grounded to filter out the current noises which flow from the voltage stabilizer L1 to the micro-controller 30. The micro-controller 30 is connected to an electric voltage Vcc. One end of the micro-controller 30 is connected to the electric voltage Vcc, and the other end of the micro-controller 30 is connected to the mode switching end S. The one end of the second component A2 is connected to the electric voltage Vcc. The second component A2 is the capacitor, the filter or the circuit with the function which is similar to the capacitor or the filter, etc.

As described above, the self-locking power supply circuit 100 arranges the PMOS transistor 40 and the NMOS transistor 50 to the electric power supply path of the battery 10. Furthermore, the micro-controller 30 outputs the signals at the different levels, so the PMOS transistor 40 and the NMOS transistor 50 are conductive to make the electric power supply path of the battery 10 be conductive, or the PMOS transistor 40 and the NMOS transistor 50 are turned off to disconnect the electric power supply path of the battery 10, so after the battery 10 leaves a factory, an electric consumption of the battery 10 is saved during a transportation period. At the same time, when a consumer initially uses an electronic device which includes the battery 10 of the self-locking power supply circuit 100, the self-locking power supply circuit 100 is able to lock the battery 10 of the self-locking power supply circuit 100 to save power consumption and the battery 10 is easily unlocked, so that a simpler user experience is provided.

Though the present invention is disclosed as the above-mentioned preferred embodiment, the preferred embodiment disclosed in this invention is without being intended to limit a scope of this invention. In related technical fields, anyone with ordinary knowledges should be able to make a few changes and embellishments within a spirit and a protection scope of this invention, so the protection scope of this invention should regard defined claims of an attached application patent as a standard.

What is claimed is:

1. A self-locking power supply circuit, comprising:
a battery;
a grounding end;
an outputting end;
a mode switching end;
a P-channel metal oxide semiconductor (PMOS) transistor including a first source electrode electrically connected to the outputting end, a first drain electrode electrically connected to the battery, and a first gate electrode;
an N-channel metal oxide semiconductor (NMOS) transistor including a second source electrode electrically connected to the grounding end, a second drain electrode electrically connected to the first gate electrode of the PMOS transistor, and a second gate electrode electrically connected to the mode switching end; and
a first resistor, one end of the first resistor being connected between the battery and the first drain electrode of the PMOS transistor, and the other end of the first resistor being connected between the first gate electrode of the PMOS transistor and the second drain electrode of the NMOS transistor.

2. The self-locking power supply circuit as claimed in claim 1, further comprising an external power supply, a voltage stabilizer and a micro-controller, the external power supply being connected between the outputting end and the voltage stabilizer, the voltage stabilizer including an outputting terminal, the micro-controller being equipped with an outputting pin, the micro-controller being connected between the outputting terminal and the mode switching end, the outputting pin being electrically connected with the mode switching end.

3. The self-locking power supply circuit as claimed in claim 2, wherein a negative electrode of a diode is connected to the outputting end, and a positive electrode of the diode is electrically connected to the external power supply.

4. The self-locking power supply circuit as claimed in claim 2, wherein the voltage stabilizer is connected between the outputting end and the micro-controller, an inputting terminal and an enabling terminal of the voltage stabilizer are electrically connected to the outputting end, the outputting terminal of the voltage stabilizer is electrically connected to the micro-controller.

5. The self-locking power supply circuit as claimed in claim 4, wherein the self-locking power supply circuit is equipped with a second resistor, one end of the second resistor is connected between the voltage stabilizer and the micro-controller, and the other end of the second resistor is connected between the micro-controller and the mode switching end.

6. The self-locking power supply circuit as claimed in claim 5, wherein the self-locking power supply circuit is equipped with a first component, one end of the first component is electrically connected between the outputting end, and the inputting terminal and the enabling terminal of the voltage stabilizer, and the other end of the first component is grounded.

7. The self-locking power supply circuit as claimed in claim 6, wherein the first component is a capacitor.

8. The self-locking power supply circuit as claimed in claim 6, wherein the first component is a filter.

9. The self-locking power supply circuit as claimed in claim 6, wherein the self-locking power supply circuit is equipped with a second component, one end of the second component is electrically connected between the second resistor and the micro-controller, and the other end of the second component is grounded.

10. The self-locking power supply circuit as claimed in claim 9, wherein the second component is a capacitor.

11. The self-locking power supply circuit as claimed in claim 9, wherein the second component is a filter.

12. A self-locking power supply circuit, comprising:
a battery;
a grounding end;
an outputting end;
a mode switching end;
a micro-controller connected between an electric voltage and the mode switching end;
a P-channel metal oxide semiconductor (PMOS) transistor including a first source electrode electrically connected to the outputting end, a first drain electrode electrically connected to the battery, and a first gate electrode;
an N-channel metal oxide semiconductor (NMOS) transistor including a second source electrode electrically connected to the grounding end, a second drain electrode electrically connected to the first gate electrode of the PMOS transistor, and a second gate electrode electrically connected to the mode switching end;
a first resistor, one end of the first resistor being connected between the battery and the first drain electrode of the PMOS transistor, and the other end of the first resistor being connected between the first gate electrode of the PMOS transistor and the second drain electrode of the NMOS transistor; and
a voltage stabilizer connected between the outputting end and the micro-controller, the voltage stabilizer connected between the outputting end and the electric voltage.

13. A self-locking power supply circuit, comprising:
a battery;
a grounding end;
an outputting end;
a mode switching end;
a micro-controller, one end of the micro-controller being connected to an electric voltage, and the other end of the micro-controller being connected to the mode switching end;
a P-channel metal oxide semiconductor (PMOS) transistor including a first source electrode electrically connected to the outputting end, a first drain electrode electrically connected to the battery, and a first gate electrode;
an N-channel metal oxide semiconductor (NMOS) transistor including a second source electrode electrically connected to the grounding end, a second drain electrode electrically connected to the first gate electrode of the PMOS transistor, and a second gate electrode electrically connected to the mode switching end;
a first resistor, one end of the first resistor being connected between the battery and the first drain electrode of the PMOS transistor, and the other end of the first resistor being connected between the first gate electrode of the PMOS transistor and the second drain electrode of the NMOS transistor.
